(19) United States
(12) Patent Application Publication
(10) Pub. No.: US 2019/0273859 A1
(43) Pub. Date: Sep. 5, 2019

(54) IMAGE CAPTURE SYSTEM AND CAPTURE PROCESS ADJUSTING METHOD THEREOF

(71) Applicant: CHICONY ELECTRONICS CO., LTD., New Taipei City (TW)

(72) Inventors: Shang-Yuan YUAN, New Taipei City (TW); Hsiang-Ping LIU, New Taipei City (TW); Yuan-Lung CHEN, New Taipei City (TW)

(21) Appl. No.: 16/169,379

(22) Filed: Oct. 24, 2018

(30) Foreign Application Priority Data
Mar. 2, 2018 (TW) 107107129

(51) Int. Cl. H04N 5/235

(52) U.S. Cl. CPC H04N 5/2353; H04N 5/2357

(57) ABSTRACT

An image capture system and a capture process adjusting method thereof are disclosed. The image capture system includes a light sensor module, a digital signal processing module, and an image sensor module. The light sensor module is used for setting a preset integration time and detecting a change in brightness of a flickering light source a plurality of times to obtain a plurality of detection results. The digital signal processing module analyzes the plurality of detection results to determine whether there is a waveform change in the plurality of detection results. The image sensor module has an automatic exposure setting value corresponding to the preset integration time. When the digital signal processing module detects the waveform change in the plurality of detection results, the digital signal processing module changes the automatic exposure setting value of the image sensor module to match the frequency of the flickering light source.

### BACKGROUND OF THE INVENTION

### 1. Field of the Invention

The present invention relates to an image capture system and a capture process adjusting method thereof, and more particularly, to an image capture system and a capture process adjusting method thereof capable of avoiding flicker.

### 2. Description of the Related Art

In modern technology, when an artificial light source such as a fluorescent lamp or a mercury vapor lamp is connected to an AC (Alternating Current) power supply with a frequency of 50 or 60 Hz, it generally has a brightness variation at a particular frequency of 100 or 120 Hz, respectively. When the exposure time of an image capture system does not match the frequency of the AC energizing an ambient light source, there is a visible change in brightness between two images. Such a phenomenon is called “Flickering”. For example, when the image capture system captures images under a flickering light source with a faster shutter speed, flicker due to the brightness variation of the light source may appear in the captured images as uneven exposure of the captured images. Moreover, when images are captured in burst mode under the flickering light source, the exposure or color of parts of the captured images is likely to be uneven, too. In the prior arts, an optimal exposure setting value was found by experimenting with different exposure setting values via an image sensor module. However, this method is usually suitable for a clean and simple background image such as a white background. When the image capture system captures images of a complex scene or when the image capture system is moved from an outdoor location to an indoor location, this method may lead to an incorrect determination.

Therefore, it is desirable to provide an improved image capture system and a capture process adjusting method thereof to mitigate and/or obviate the aforementioned problems.

### SUMMARY OF THE INVENTION

It is a main object of the present invention to provide an image capture system having the effect of avoiding flicker.

It is another main object of the present invention to provide a capture process adjusting method used in the aforementioned system.

In order to achieve the above-mentioned objects, the image capture system of the present invention is used in an environment with a flickering light source. The image capture system comprises a light sensor module, a digital signal processing module, and an image sensor module. The light sensor module is used for setting a preset integration time and detecting a change in brightness of the flickering light source a plurality of times to obtain a plurality of detection results. The digital signal processing module is electrically connected to the light sensor module. Moreover, the digital signal processing module analyzes the plurality of detection results to determine whether there is a waveform change in the plurality of detection results. The image sensor module is electrically connected to the digital signal processing module. Moreover, the image sensor module has an automatic exposure setting value corresponding to the preset integration time. When the digital signal processing module detects no waveform change in the plurality of detection results, the image sensor module leaves the automatic exposure setting value unchanged. When the digital signal processing module detects the waveform change in the plurality of detection results, the digital signal processing module changes the automatic exposure setting value of the image sensor module to match the frequency of the flickering light source.

The capture process adjusting method of the present invention comprises the following steps: setting a preset integration time and detecting a change in brightness of a flickering light source a plurality of times to obtain a plurality of detection results; analyzing the plurality of detection results to determine whether there is a waveform change in the plurality of detection results; leaving an automatic exposure setting value of the image capture system unchanged if no waveform change is detected in the plurality of detection results, wherein the automatic exposure setting value corresponds to the preset integration time; and changing the automatic exposure setting value to match the frequency of the flickering light source if a waveform change is detected in the plurality of detection results.

### BRIEF DESCRIPTION OF THE DRAWINGS

FIG. 1 is a schematic drawing of the structure of an image capture system of the present invention; and

FIG. 2 is a flowchart showing the steps of a capture process adjusting method of the present invention.

### DETAILED DESCRIPTION OF THE PREFERRED EMBODIMENT

The advantages and innovative features of the invention will become more apparent from the following detailed description when taken in conjunction with the accompanying drawings.

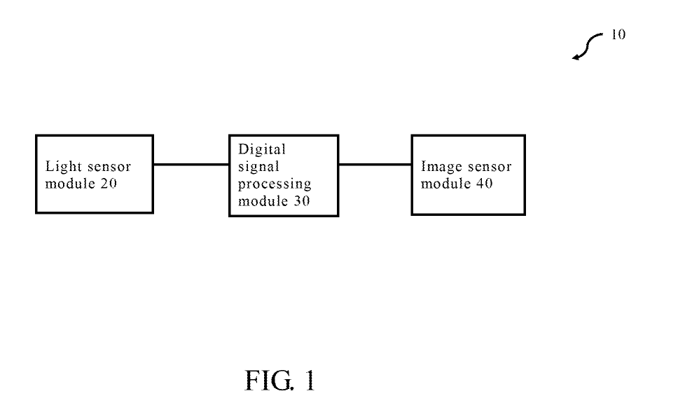

First, for the following description, please refer to FIG. 1. FIG. 1 is a schematic drawing of the structure of an image capture system of the present invention.

In one embodiment of the present invention, an image capture system 10 is used in an environment with a flickering light source. The flickering light source can be an artificial light source which can give rise to flicker such as a fluorescent lamp or a mercury vapor lamp. The electric power of a fluorescent lamp or a mercury vapor lamp is usually provided by mains power. Thus, the frequency of the flickering light source may be twice the mains supply frequency. In Taiwan, the mains supply frequency is 60 Hz. In Europe and North America, the mains supply frequency is 50 Hz. Therefore, the frequency of the flickering light source may be 120 Hz or 100 Hz. The image capture system 10 comprises a light sensor module 20, a digital signal processing module 30, an image sensor module 40, and other image processing modules. Other image processing procedures are not the primary issue of the present invention and thus are not elaborated upon. The light sensor module 20 can detect the brightness of an external light source in real time. Therefore, in this embodiment, the light sensor module 20 is used for setting an integration time and detecting a change in brightness of the flickering light source according to the integration time. In one embodiment of the present invention, the preset integration time according to the frequency of the flickering light source is 1/120 of a second so as to correspond to the preset frequency of the mains supply, which is 60 Hz, consistent with the operating environment in Taiwan. Moreover, the light sensor module 20 continuously detects the change in brightness of the flickering light source a plurality of times to obtain a plurality of detection results. Each detection result shows the variation waveform of the flickering light source. In one embodiment of the present invention, the light sensor module 20 detects the change in brightness of the flickering light source five times repeatedly. However, the present invention is not limited to that number of times.

The digital signal processing module 30 is electrically connected to the light sensor module 20. Moreover, the digital signal processing module 30 analyzes the plurality of detection results to determine whether there is a waveform change in the plurality of detection results. When the integration time set by the light sensor module 20 does not correspond to the frequency of the mains supply, that is to say, when the preset integration time is 1/120 of a second but the frequency of the mains supply is 50 Hz, the generated waveforms will be different between different instances of detection results detected by the light sensor module 20. The image sensor module 40 is electrically connected to the digital signal processing module 30 and is able to capture images. The image sensor module 40 has an automatic exposure setting value, which can be set by the digital signal processing module 30. However, please note that the scope of the present invention is not limited to the above description. The automatic exposure setting value corresponds to the preset integration time. In this embodiment, the automatic exposure setting value is preset to correspond to 1/120 of a second so as to correspond to the frequency of the mains supply, which is 60 Hz, consistent with the operating environment in Taiwan.

As we know from the above, when the digital signal processing module 30 detects no waveform change in the plurality of detection results, it means that the original setting of the image sensor module 40 can correspond to the frequency of the mains supply, which is 60 Hz in this embodiment. Thus, the image sensor module 40 leaves the automatic exposure setting value unchanged. When the digital signal processing module 30 detects the waveform change in the plurality of detection results, it means that the original setting of the image sensor module 40 does not match the frequency of the present mains supply, which is 50 Hz in this embodiment. Thus, the digital signal processing module 30 changes the automatic exposure setting value of the image sensor module 40 to match the frequency of the flickering light source.

It is noted that the modules of the image capture system 10 may individually be configured as a hardware device, a combination of a software program and a hardware device, a combination of firmware and a hardware device, or other unspecified combinations. However, please note that the scope of the present invention is not limited to the above description. In addition, the embodiment described is a preferred embodiment of the present invention provided for reference. Not all possible combinations are described in detail to avoid redundancy. However, those skilled in the art may understand that not all the aforementioned modules or units are necessary. Other detailed modules or units of the prior art may be included in order to execute the present invention. Any of the modules or units can be omitted or modified depending on user requirements, and other modules or units may or may not exist between any two modules.

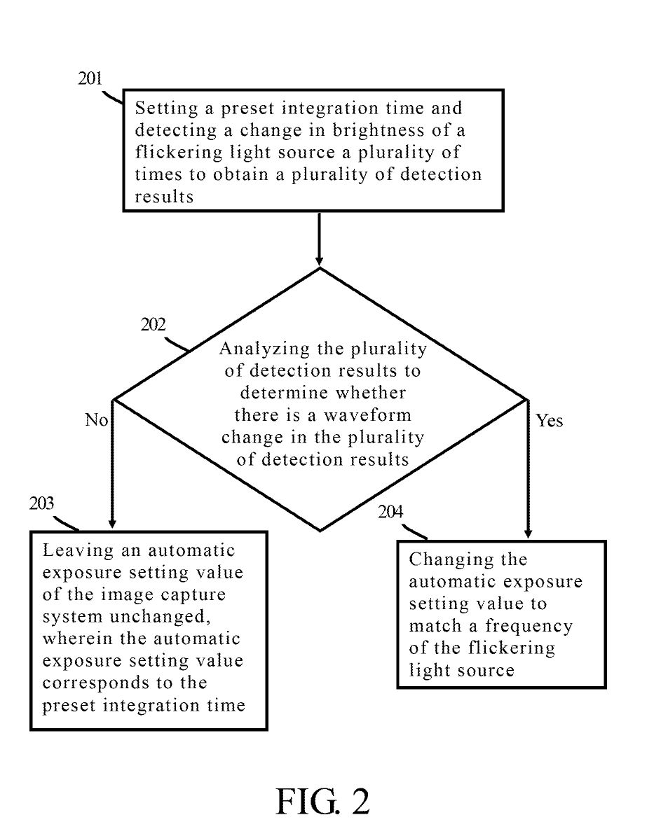

Next, please refer to FIG. 2, which is a flowchart showing the steps of a capture process adjusting method of the present invention. Please note that the capture process adjusting method of the present invention is described in the following paragraphs with the example of the aforementioned image capture system 10; however, the capture process adjusting method of the present invention is not limited to the use of the aforementioned image capture system 10 or an equivalent device.

The present invention performs step 201 first: setting a preset integration time and detecting a change in brightness of a flickering light source a plurality of times to obtain a plurality of detection results.

First, a light sensor module 20 sets a preset integration time and detects a change in brightness of a flickering light source. Moreover, the light sensor module 20 continuously performs the detection process to obtain a plurality of detection results.

Next, the present invention performs step 202: analyzing the plurality of detection results to determine whether there is a waveform change in the plurality of detection results.

Next, a digital signal processing module 30 analyzes the plurality of detection results to determine whether there is a waveform change in the plurality of detection results so as to determine whether an automatic exposure setting value of an image sensor module 40 matches the frequency of the present flickering light source.

If the digital signal processing module 30 detects no waveform change in the plurality of detection results, the preset invention performs step 203: leaving an automatic exposure setting value of the image capture system unchanged, wherein the automatic exposure setting value corresponds to the preset integration time.

The automatic exposure setting value corresponds to the preset integration time. Thus, if no waveform change is detected in the plurality of detection results, it means that the integration time set by the light sensor module 20 corresponds to the frequency of the mains supply. This further means that the automatic exposure setting value of the image sensor module 40 matches the frequency of the flickering light source. Therefore, the image sensor module 40 leaves the automatic exposure setting value unchanged.

Last, if the digital signal processing module 30 detects the waveform change in the plurality of detection results, the present invention performs step 204: changing the automatic exposure setting value to match a frequency of the flickering light source.

Last, if the waveform change is detected in the plurality of detection results, it means that the integration time set by the light sensor module 20 cannot correspond to the frequency of the mains supply. Also, it means that the original setting of the image sensor module 40 does not match the frequency of the present flickering light source. Thus, in this case, the digital signal processing module 30 changes the automatic exposure setting value of the image sensor module 40 to match the frequency of the flickering light source.

It is noted that the capture process adjusting method of the present invention is not limited to the order of the steps mentioned above. As long as the object of the present invention is achieved, the order of the steps mentioned above can be varied.

As stated above, the image capture system 10 of the present invention can change the automatic exposure setting value in real time according to the frequency of the flickering light source, which corresponds to the frequency of the mains supply, to avoid flicker when an image is captured.

It is noted that the embodiment described is a preferred embodiment of the present invention provided for reference. Not all possible combinations are described in detail to avoid redundancy. However, those skilled in the art may understand that not all the aforementioned modules or units are necessary. Other detailed modules or units of the prior art may be included in order to execute the present invention. Any of the modules or units can be omitted or modified depending on user requirements, and other modules or units may or may not exist between any two modules. Furthermore, it is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. An image capture system, used in an environment with a flickering light source, comprising:
a light sensor module used for setting a preset integration time and detecting a change in brightness of the flickering light source a plurality of times to obtain a plurality of detection results;
a digital signal processing module electrically connected to the light sensor module, the digital signal processing module analyzing the plurality of detection results to determine whether there is a waveform change in the plurality of detection results; and
an image sensor module electrically connected to the digital signal processing module, the image sensor module having an automatic exposure setting value corresponding to the preset integration time, wherein when the digital signal processing module detects no waveform change in the plurality of detection results, the image sensor module leaves the automatic exposure setting value unchanged;
when the digital signal processing module detects the waveform change in the plurality of detection results, the digital signal processing module changes the automatic exposure setting value of the image sensor module to match a frequency of the flickering light source.

2. The image capture system as claimed in claim 1, wherein the light sensor module detects the change in brightness of the flickering light source five times repeatedly.

3. The image capture system as claimed in claim 1, wherein the preset integration time is 1/120 of a second.

4. A capture process adjusting method, used in an image capture system, the image capture system being used in an environment with a flickering light source, the capture process adjusting method comprising:
setting a preset integration time and detecting a change in brightness of the flickering light source a plurality of times to obtain a plurality of detection results;
analyzing the plurality of detection results to determine whether there is a waveform change in the plurality of detection results;
leaving an automatic exposure setting value of the image capture system unchanged if no waveform change is detected in the plurality of detection results, wherein the automatic exposure setting value corresponds to the preset integration time; and
changing the automatic exposure setting value to match a frequency of the flickering light source if the waveform change is detected in the plurality of detection results.

5. The capture process adjusting method as claimed in claim 4, wherein the change in brightness of the flickering light source is detected five times repeatedly.

6. The capture process adjusting method as claimed in claim 4, wherein the preset integration time is 1/120 of a second.
